(19) United States
(12) Patent Application Publication
(10) Pub. No.: US 2016/0124069 A1
(43) Pub. Date: May 5, 2016

(54) SYSTEMS AND METHODS FOR ESTIMATING A TWO-DIMENSIONAL POSITION OF A RECEIVER

(71) Applicant: NextNav, LLC, Sunnyvale, CA (US)

(72) Inventors: Andrew Sendonaris, Los Gatos, CA (US); Subramanian S. Meiyappan, San Jose, CA (US); Jagadish Venkataraman, San Jose, CA (US)

(21) Appl. No.: 14/881,120

(22) Filed: Oct. 12, 2015

Related U.S. Application Data
(60) Provisional application No. 62/069,990, filed on Oct. 29, 2014.

(51) Int. Cl. G01S 5/02; G01S 5/10

(52) U.S. Cl. CPC G01S 5/0226; G01S 5/10

(57) ABSTRACT

Estimating a two-dimensional position of a receiver based on an altitude of an object other than the receiver in a geographical region within which the receiver is believed to reside. In one embodiment, when a high-accuracy estimate of the receiver's altitude is available, latitude and longitude coordinates of the receiver are estimated using the high-accuracy estimate of the receiver's altitude. When the high-accuracy estimate of the receiver's altitude is not available, the latitude and longitude coordinates of the receiver are estimated using an alternative altitude value that is based on one or more altitudes of one or more things other than the receiver.

### RELATED APPLICATIONS

This application relates to U.S. Patent Application Ser. No. 62/069,990, filed Oct. 29, 2014, entitled SYSTEMS AND METHODS FOR ESTIMATING A TWO-DIMENSIONAL POSITION OF A RECEIVER, the content of which is hereby incorporated by reference herein in its entirety.

### FIELD

Various embodiments relate to wireless communications, and more particularly, to networks, devices, methods and machine-readable media for estimating a two-dimensional position of a receiver in a three-dimensional space when an estimate of the receiver's height is not available or is not accurate.

### BACKGROUND

Quickly and accurately estimating locations of things in a geographic area can be used to speed up emergency response times, track business assets, and link consumers to nearby businesses. Various techniques are used to estimate the position of a thing in a geographic area. One such technique is trilateration, which is the process of using geometry to estimate the position of the thing (e.g., a receiver) using distances traveled by different signals that are transmitted from geographically-distributed transmitters and later received by that thing.

Urban environments pose challenges that lengthen the time it takes to accurately estimate the thing's location, mainly because the distances traveled by the different signals are longer than the actual distance between the thing and the transmitters that transmitted the signals. These longer distances are the consequence of the signals reflecting off of buildings that are located between the thing and the transmitters. Unfortunately, these longer distances result in less accurate estimates of the thing's position and/or longer periods of time during which a sufficiently-accurate estimate of the thing's position is computed.

In an urban environment, the length of time it takes to determine two dimensions of a thing's position (e.g., the thing's latitude and longitude), can take as long as the time needed to determine three dimensions of the thing's position (e.g., the thing's latitude, longitude and altitude). This is because the thing and the transmitters are at different three-dimensional combinations of latitude, longitude and altitude, so one must solve for all three dimensions. In many cases, however, only the two-dimensional position is needed. Thus, there is a need for improved techniques for determining a thing's two-dimensional position (e.g., latitude and longitude) without needing to estimate the third dimension of the thing's position (e.g., altitude).

### SUMMARY

Various embodiments, but not necessarily all embodiments, described in this disclosure relate generally to networks, devices, methods, means and machine-readable media for estimating latitude and longitude coordinates of a receiver. Such networks, devices, methods, means and machine-readable media may first determine whether an estimate of a receiver's altitude is available. When the estimate of the receiver's altitude is available, latitude and longitude coordinates of the receiver may be estimated using the estimate of the receiver's altitude. When the estimate of the receiver's altitude is not available, the latitude and longitude coordinates of the receiver may be estimated using an alternative altitude value that is based on altitude(s) of transmitter(s) or other thing(s).

The details of one or more embodiments of the invention are set forth in the accompanying drawings and the description below.

### BRIEF DESCRIPTION OF THE DRAWINGS

FIG. 1 depicts a positioning system on which different embodiments are implemented for estimating a two-dimensional position of a receiver in a three-dimensional space when an estimate of the receiver's height is not available or is not accurate.

FIG. 2 depicts a transmitter system for use in the positioning system of FIG. 1.

FIG. 3 depicts a receiver system for use in the positioning system of FIG. 1.

FIG. 4 illustrates a process for estimating a two-dimensional position of a receiver using one or more approaches.

FIG. 5A illustrates a process for estimating a two-dimensional position of a receiver using an alternative altitude value that is based on one or more altitudes of one or more transmitters.

FIG. 5B illustrates a process for estimating a two-dimensional position of a receiver using an alternative altitude value that is based on one or more altitudes of one or more things in a region within which a receiver is believed to reside.

FIG. 6 depicts a positioning system for estimating a two-dimensional position of a receiver using an alternative altitude value that is based on one or more altitudes of one or more transmitters.

FIG. 7 depicts a positioning system for estimating a two-dimensional position of a receiver using an alternative altitude value that is based on one or more altitudes of one or more things in a region within which a receiver is believed to reside.

FIG. 8 depicts a data source for use in determining various alternative altitude values that are used to determine a two-dimensional position of a receiver.

Like reference numbers and designations in the drawings indicate like elements.

### DETAILED DESCRIPTION

In urban environments, a three-dimensional estimate of a thing's position is required within a relatively short period of time (e.g., within seconds for emergency calls and navigation applications). The estimate must be within a certain distance from the thing's true three-dimensional position. For emergency calls from a mobile phone, an estimate of a person's position typically should be determined within 30 seconds and typically should be within a few meters of the person's actual position. However, challenges posed by urban environments make it difficult to meet these requirements.

In some cases, a quick and accurate two-dimensional estimate of the thing's position may be satisfactory (at least initially), and the third dimension can be accurately determined at a later time, determined by a different method, or not be determined at all. In many of these cases, a thing's latitude and longitude are the two critical dimensions, and the thing's altitude is a less critical dimension. Estimating a two-dimensional position of a thing can be as slow as estimating a three-dimensional position of a thing, since there are three variables to estimate (e.g., latitude, longitude and altitude). It follows that the time to estimate two of those variables can be shortened if the third variable is known. Unfortunately, the third variable is often not known.

This disclosure describes various approaches for estimating the latitude and longitude of a thing (e.g., a receiver) using an alternative altitude value that is based on one or more altitudes of other things (e.g., a nearby transmitter, a nearby feature of the geographical region, a nearby phone, a nearby beacon, or another type of thing). Using such an alternative altitude value decreases the time needed to estimate a two-dimensional position of the receiver with an acceptable level of accuracy compared to knowing the altitude of the receiver.

### Example Systems

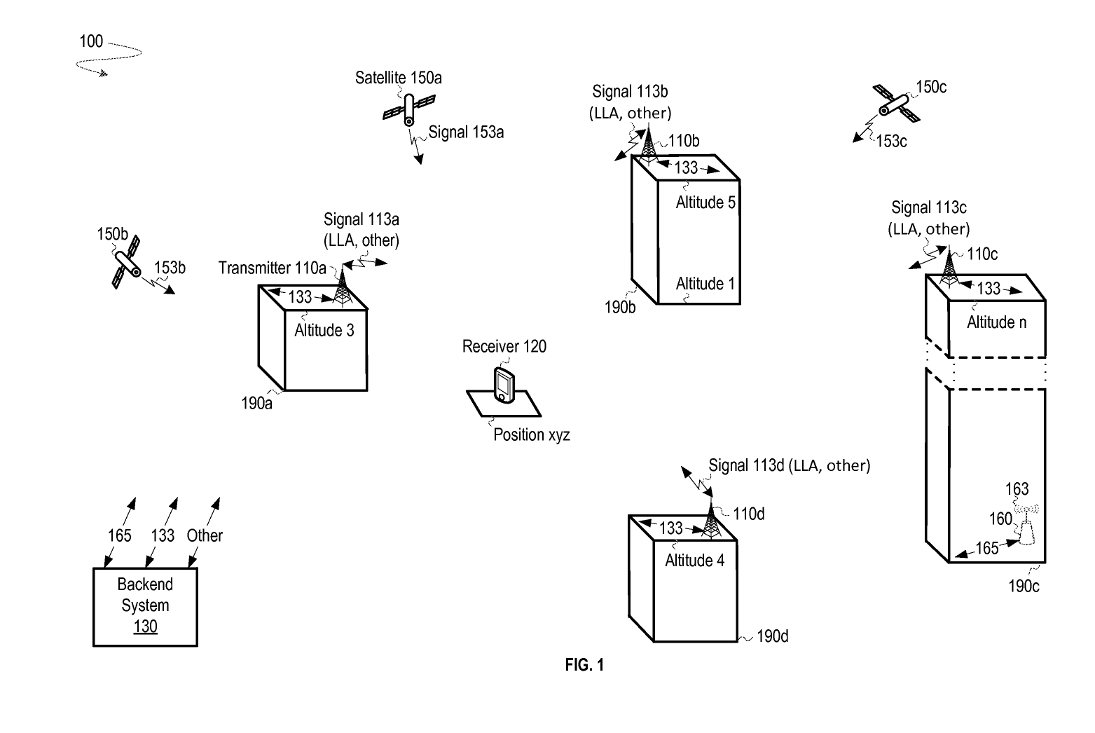

FIG. 1 illustrates a positioning system 100 on which various embodiments may be implemented. The positioning system 100 includes any number of receiver systems (“receivers”) 120 that receive signals from and/or send signals to transmitter systems (“transmitters”) 110, satellite systems (“satellites”) 150, and/or other systems (“nodes”) 160 via corresponding communication links 113, 153 and 163, respectively. The receivers 120 may also receive signals from and/or send signals to other receivers 120 and a backend system (“backend”) 130 like a server (connectivity not shown).

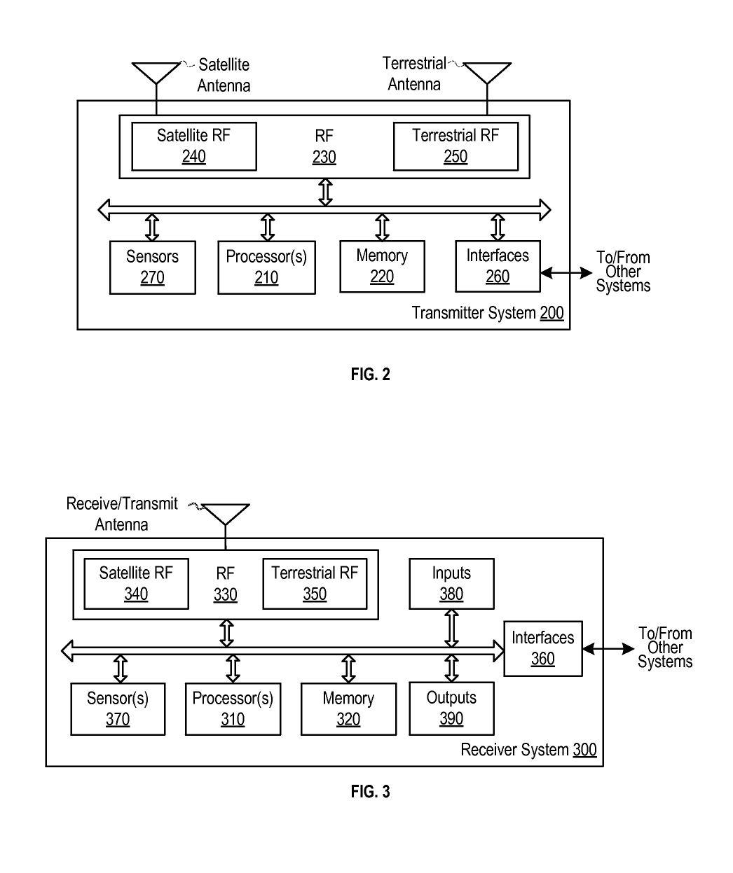

The transmitters 110 transmit the signals 113, which are received by any of the receivers 120. The transmitters 110 also communicate with the backend 130 via the communication links 133. In some embodiments, the transmitters 110 may transmit the signals 113 using one or more common multiplexing parameters—e.g. time slot, pseudorandom sequence, or frequency offset. Each of the signals 113 from each of the transmitters 110 may carry different information that, once extracted by the receiver 120 or the backend 130, may identify the following: the transmitter that transmitted the signal; the latitude, longitude and altitude (LLA) of that transmitter; pressure, temperature and other atmospheric conditions at or near that transmitter; ranging information that is used to measure a distance to that transmitter; and other information. Additional details regarding the transmitters 110 are provided below in relation to FIG. 2.

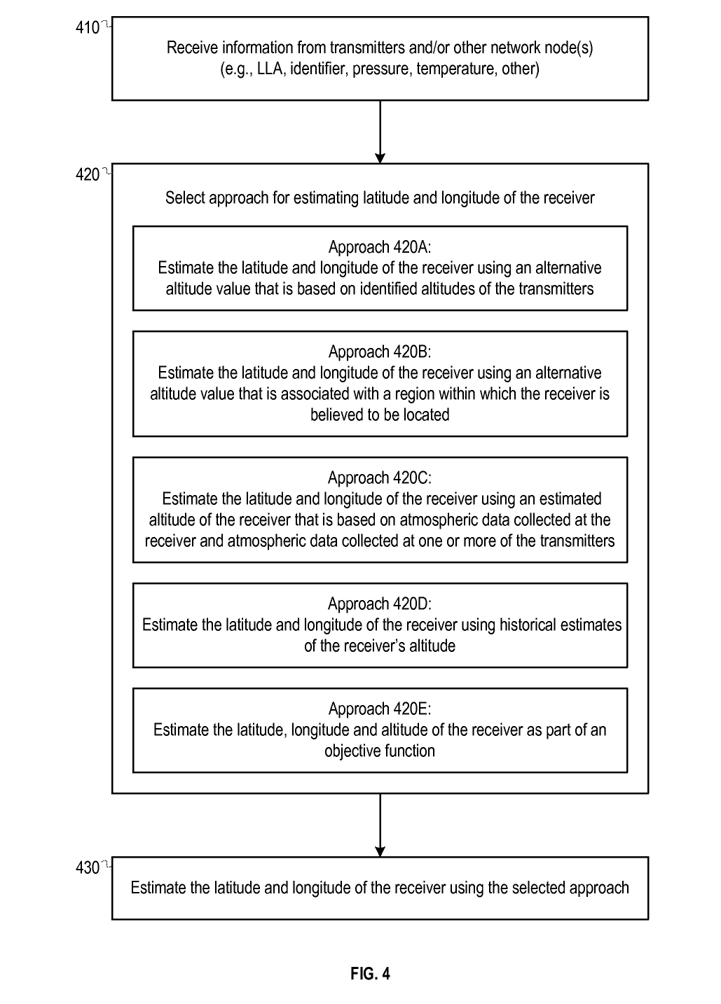

The receiver 120 may include a location computation engine (not shown) to determine positioning information using the signals 113, 153, and/or 163 received from the transmitters 110, the satellites 150, and/or the nodes 160. The receiver 110 may also include a signal processing component (not shown) that: demodulates received signals from beacons (e.g., the transmitters 110, satellites 150, and/or nodes 160); estimates positioning information like travel time of the received signals based on estimated times of arrival (TOAs) for those signals, and measurements of range to the beacons based on the estimated travel times of the received signals; refines the positioning information; and uses the positioning information to estimate the position of the receiver 120 using suitable processes like trilateration. Additional details regarding the receiver 120 are provided below in relation to FIG. 3.

One of ordinary skill in the art will appreciate that methods described herein may be carried out using processors at any or all of the transmitters 110, the receivers 120, the backend 130, and/or other components.

### Example Transmitter Systems

FIG. 2 illustrates details of a transmitter system (“transmitter”) 200 at which signals may be generated and transmitted. The transmitter 200 may include a processor 210 that carries out signal processing (e.g., interpreting received signals and generating signals for transmission to other systems). Memory 220 may provide storage and retrieval of data and/or executable instructions for performing methodologies described herein. The transmitter 200 includes satellite and a terrestrial antenna(s) for transmitting and receiving signals, and also includes RF components 230. FIG. 2 depicts a satellite RF component 240 for receiving satellite signals and a terrestrial RF component 250 for generating and sending signals to other systems like the receiver 120. Generation of signals may be carried out using analog/digital logic and power circuitry, signal processing circuitry, tuning circuitry, buffer and power amplifiers, and other components known by one of ordinary skill in the art. The transmitter 200 may also include an interface 260 for exchanging information with other systems. The transmitter 200 may further include one or more environmental sensors 270 for sensing environmental conditions (e.g., pressure, temperature, humidity, wind, sound, or other), which may be compared to such conditions as sensed at the receiver 120 in order to estimate a position of the receiver 120.

### Example Receiver Systems

FIG. 3 illustrates details of a receiver system (“receiver”) 300, at which signals from beacons (e.g., the transmitters 110, satellites 150 and nodes 160 in FIG. 1) may be received and processed to extract information used to compute an estimated position of the receiver 300. FIG. 3 shows RF components 330 that control the exchange of information with other systems. Signal processing occurs at a satellite RF component 340 (e.g., a GNSS chip like a GPS chip), a terrestrial RF component 350, or other suitable component, which use separate or shared resources such as antennas, RF circuitry, processors and the like to perform signal processing as is known in the art or otherwise disclosed herein. Memory 320 is coupled to a processor 310 to provide storage and retrieval of data and/or instructions relating to processes described herein that may be executed by the processor 310. The processor 310 may form all or part of a positioning engine that determines positioning information from signaling received from other systems. The receiver 300 further includes one or more sensors 370 for measuring environmental conditions like pressure, temperature, humidity, inertial (e.g., acceleration, velocity, orientation), imaging, wind force, wind direction, light, sound, or other conditions associated with the receiver 300. Input and output (I/O) components 380 and 390 may include a keypad, touchscreen display, camera, microphone, speaker, or other components that permit a user to interact with the receiver 300.

### Approaches for Estimating a Two-Dimensional Position

Various approaches for estimating a two-dimensional position of a thing are described below. Examples of these approaches are described in relation to a receiver in an urban environment. Other things and other environments are also contemplated even if not described.

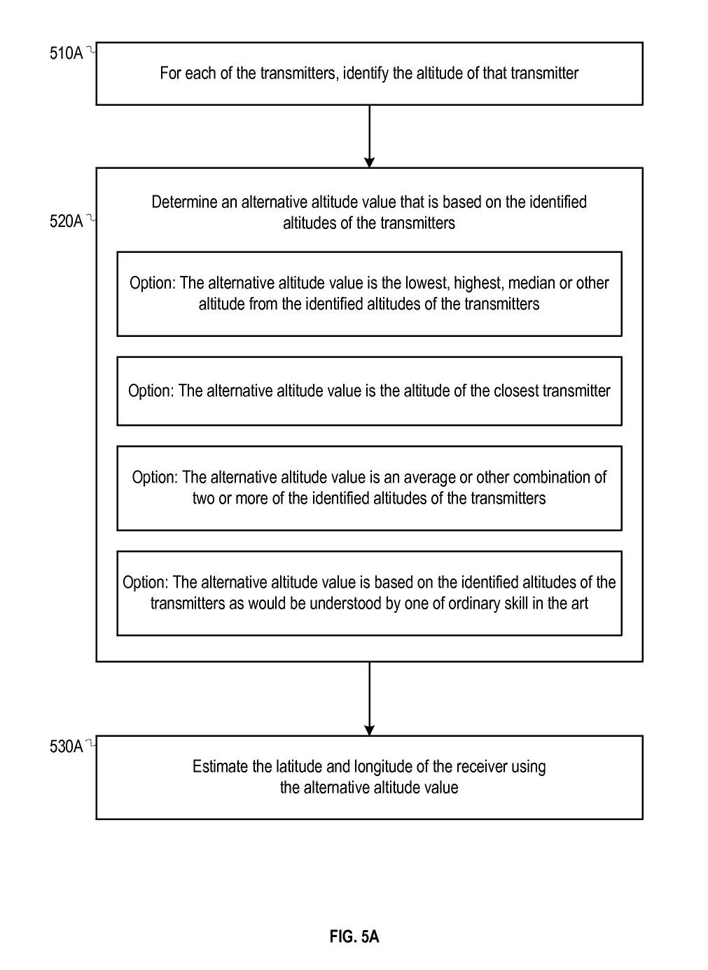

Attention is drawn to FIG. 4, which illustrates a process for estimating a two-dimensional position of the receiver 120 using one or more approaches. As shown, the receiver 120 extracts information carried by signals transmitted from each of one or more beacons, such as the transmitters 110 and/or the local network nodes 160 (410).

The information extracted from one signal may specify various characteristics or environmental conditions that are associated with the beacon that transmitted that signal. By way of example, such characteristics or conditions include: the beacon's latitude, longitude and altitude (LLA); an identifier of the beacon; a pressure and a temperature measured at or near (e.g., within 2-5 meters of) the beacon; or another characteristic or condition. The beacon's identifier, for example, may be used to look up additional information associated with that beacon, including a region within which that beacon is located, a height associated with that region, and other information.

As shown in FIG. 4, after the information is extracted from the signal, the receiver 120 or the backend system 130 selects an approach for estimating latitude and longitude of the receiver 120 (420). The receiver 120 or the backend system 130 then estimates the latitude and longitude of the receiver 120 using the selected approach (430). Various approaches for estimating the latitude and longitude are contemplated, including use of a known altitude of the receiver 120, use of an estimated altitude of the receiver 120, or use of an alternative altitude value during trilateration processing. Several approaches are illustrated in FIG. 4, including approaches 420A through 420E. Each of these approaches is described below.

### Use of an Alternative Altitude Value that is Based on Altitude(s) of Transmitter(s)

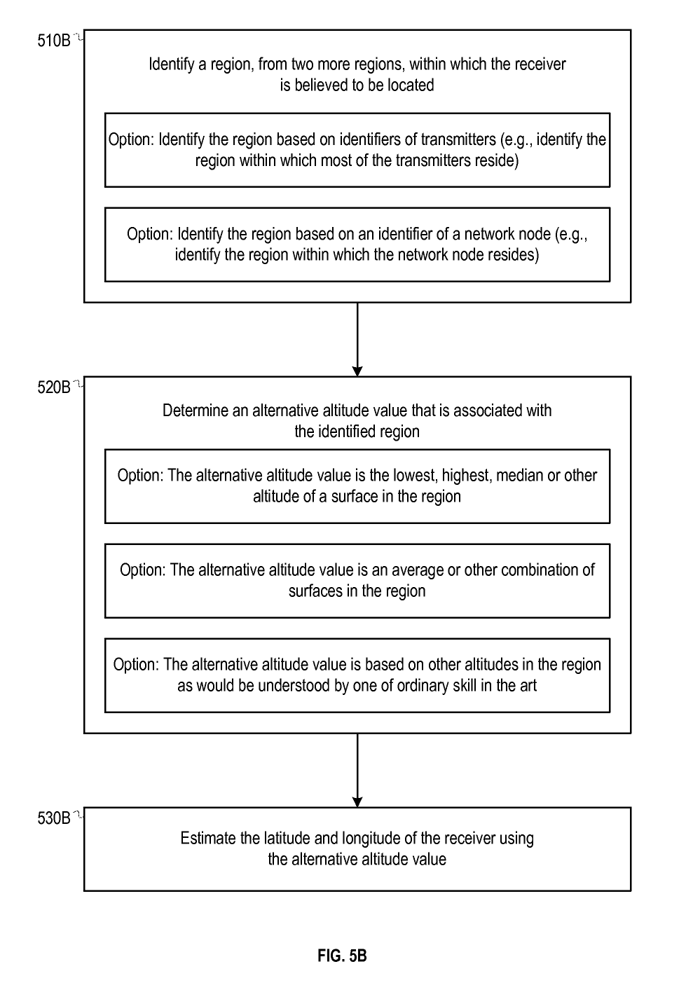

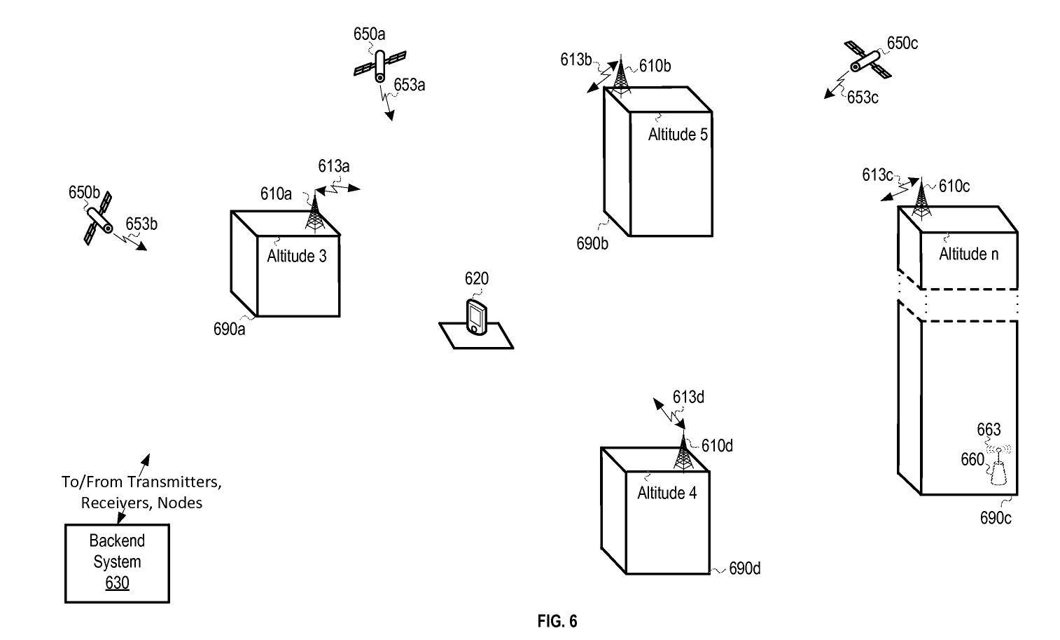

Under Approach 420A, a two-dimensional position (e.g., the latitude and longitude) of the receiver 120 is estimated using an alternative altitude value that is based on identified altitudes of the transmitters 110 (or other beacons). FIG. 5A illustrates an example process for estimating the two-dimensional position of a receiver using an alternative altitude value that is based on one or more altitudes of one or more terrestrial transmitters. While discussing the process of FIG. 5A, attention is given to FIG. 6, which depicts a positioning system for estimating the two-dimensional position of a receiver 620 using an alternative altitude value that is based on one or more altitudes of one or more transmitters 610.

As illustrated in FIG. 5A, the receiver 620 or a backend 630 identifies an altitude for each of the transmitters 610a through 610d, which each transmit their altitude along with latitude and longitude via signals 613a through 613d (510A).

The receiver 620 or the backend 630 determines an alternative altitude value that is based on one or more of the identified altitudes of the transmitters 610a through 610d (520A). In one embodiment, the alternative altitude value is the lowest, highest, median or other altitude from the identified altitudes of the transmitters 610a through 610d. In another embodiment, the alternative altitude value is altitude of the closest transmitter (e.g., ‘Altitude 3’ of transmitter 610a). For example, the closest transmitter may be determined using a rough estimate of the latitude and longitude of the receiver 620, a previously estimated latitude and longitude of the receiver 620, or may be determined using the latitude and longitude of another beacon (e.g., WiFi, other local area network) that is within range of the receiver 620. In yet another embodiment, the alternative altitude value is an average or other mathematical combination of two or more identified altitudes of the transmitters 610a through 610d. Of course, other alternative altitude values that are based on the identified altitudes of the transmitters 610a through 610d are possible, as would be understood by one of ordinary skill in the art.

Once the alternative altitude value is determined, the receiver 620 or the backend 630 estimates the latitude and longitude of the receiver 620 using that alternative altitude value during trilateration processing (530A).

### Use of an Alternative Altitude Value that is Based on Altitude(s) in a Region

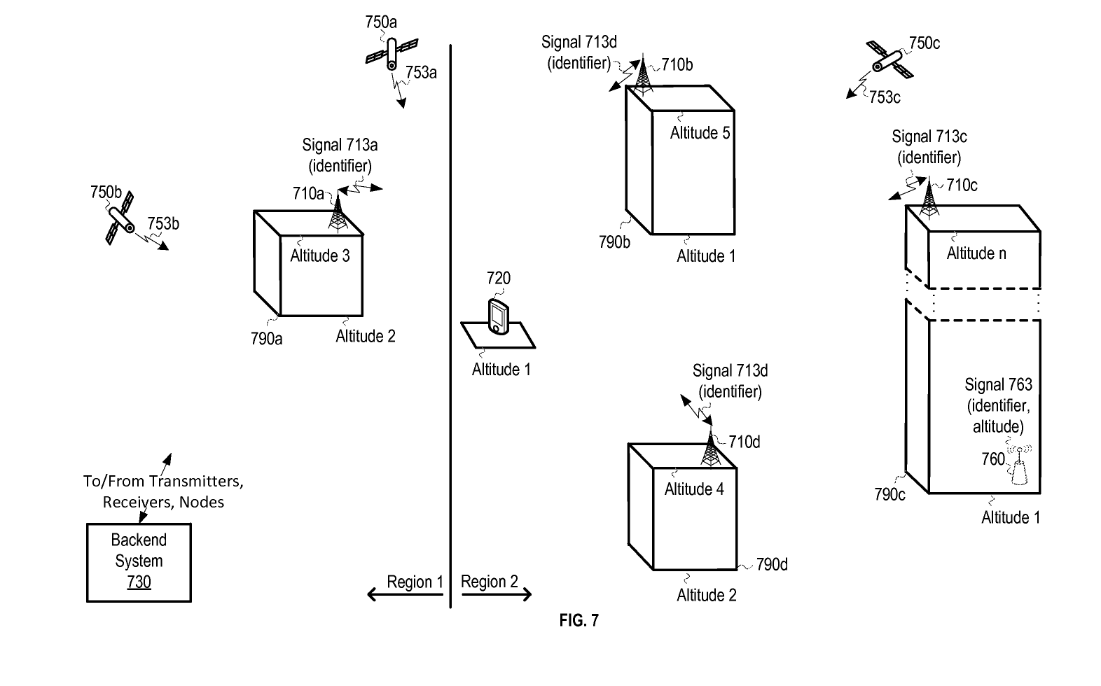

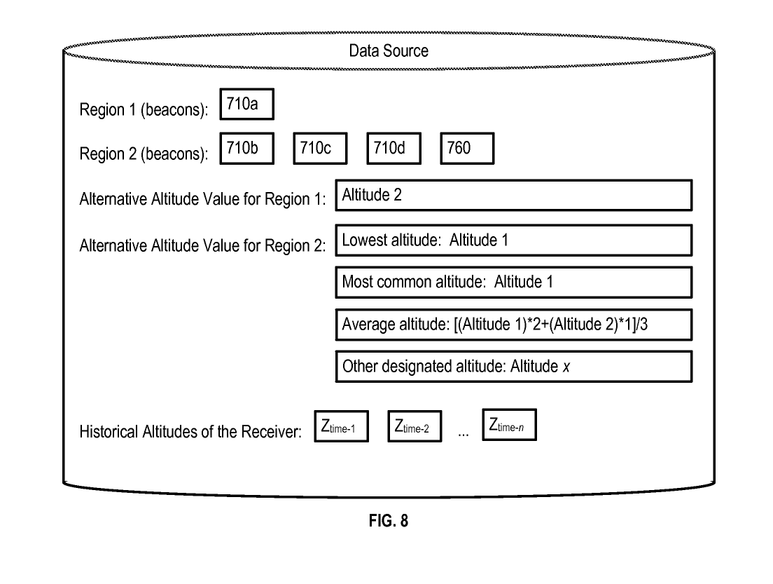

Under Approach 420B, a two-dimensional position (e.g., the latitude and longitude) of the receiver 120 is estimated using an alternative altitude value that is associated with a region within which the receiver 120 is believed to be located. FIG. 5B illustrates an example process for estimating the two-dimensional position of a receiver using an alternative altitude value that is based on one or more altitudes of one or more things associated with a region within which the receiver is believed to reside. While discussing the process illustrated in FIG. 5B, attention is given to FIG. 7, which depicts a positioning system for estimating the two-dimensional position of a receiver 720 using an alternative altitude value that is based on one or more altitudes of one or more things in a region within which the receiver 720 is believed to reside. Further attention is given to FIG. 8, which depicts information stored in a data source for use in determining the alternative altitude value.

As illustrated in FIG. 5B, the receiver 720 or a backend 730 determines a region (e.g., Region 2), from among other regions (e.g., Region 1), within which the receiver 720 is believed to be located (510B). This determination may be made in various ways. For example, a rough estimate of the latitude and longitude of the receiver 720 may indicate that the receiver 720 is more likely in Region 2 than in Region 1. By way of another example, detection of a signal from a certain transmitter (e.g., a signal 713c from transmitter 710c), or detection of signals from multiple transmitters (e.g., signals 713a through 713d from transmitters 710a through 710d) may indicate that the receiver 720 is more likely in Region 2 than Region 1 given known locations of the transmitter(s) 710a through 710d relative to each other or other transmitters.

In one embodiment, the receiver 720 or the backend 730 identifies each of the transmitters 710a through 710d using identifiers extracted from the signals 713a through 713d. The receiver 720 or the backend 730 may then consult the data source of FIG. 8, which can reside at any system, to determine which region(s) include the identified transmitters 710a, 710b, 710c and 710d. Once regions are identified (e.g., Region 1 and Region 2), the receiver 720 or the backend 730 selects the region that contains the most transmitters (e.g., Region 2, which includes transmitters 710b, 710c and 710d) as the region that is most-likely to include the receiver 720. Of course, other selection criteria are possible.

In another embodiment, the receiver 720 or the backend 730 identifies a local network node 760 (e.g., a broadcasting beacon of a local area network like a Wi-Fi network). In one implementation, the node 760 is identified via an identifier extracted from a signal 763 broadcasted by the node 760, and the receiver 720 or the backend 730 consults the data source of FIG. 8 to determine which region includes the node 760 (e.g., Region 2). The receiver 720 or the backend 730 may then select the region of the node 760 as the region that is most-likely to include the receiver 720.

Once the region of the receiver 720 is identified, the receiver 720 or the backend 730 determines an alternative altitude value that is associated with the identified region (520B). In one embodiment, the alternative altitude value is the lowest, highest, median or other altitude of a surface in the region. By way of example, the ground-level surface of Region 1 is ‘Altitude 2’ (see building 790a), and the ground surface of Region 2 varies between ‘Altitude 1’ (see buildings 790b and 790c) and ‘Altitude 2’ (see building 790d). By way of example, FIG. 8 shows four alternative altitude values for Region 2, including ‘Altitude 1’ (e.g., the lowest ground-level altitude shown in FIG. 7), ‘Altitude 1’ (e.g., the most common ground-level altitude shown in FIG. 7), an average of the three ground-level altitudes shown in FIG. 7, and ‘Altitude x’ (e.g., a predetermined altitude designated for Region 2). Of course, surfaces other than the ground-level surface of a region may be considered, including surfaces of floors in buildings and other things in a region. Other alternative altitude values that are based on other altitudes in the region are also possible.

It is to be understood that a beacon may broadcast the alternative altitude value to avoid having to look up the alternative altitude value from the data source. For example, the node 760 can broadcast the alternative altitude value.

Once the alternative altitude value is determined, the receiver 720 or the backend 730 estimates the latitude and longitude of the receiver 720 using that alternative altitude value during trilateration processing (530B).

### Use of a High-Accuracy Estimate of the Receiver's Altitude

Under Approach 420C, a two-dimensional position (e.g., the latitude and longitude) of the receiver 120 is estimated using an estimated altitude of the receiver that is based on a pressure measurement collected at the receiver 120 and a pressure measurement collected at one or more of the transmitters 110. Further details of Approach 420C are provided in U.S. patent application Ser. No. 13/296,067, filed Nov. 14, 2011, which is incorporated herein in its entirety and for all purposes, except where its content conflicts with the content of this disclosure.

### Use of an Alternative Altitude Value that is Based on Historical Altitude(s) of the Receiver

Under Approach 420D, a two-dimensional position (e.g., the latitude and longitude) of the receiver 120 is estimated using historical altitude estimates of the receiver 120. For example, historical altitude estimates of the receiver 120 may be tracked over time to determine when and where the receiver 120 is likely to be at certain times of a day, and on certain days of the week based on the past behavior of the receiver. By way of example, FIG. 8 shows historical altitudes (Z) of a receiver at previous times (e.g., time-1 through time-n).

Under Approach 420D, the two-dimensional position of the receiver 120 on a particular day of the week and at a particular time of day may be determined using a historical altitude estimate of the receiver 120 that was estimated during a previous week on that particular day of the week and at or near (e.g., with a threshold amount of minutes from) that particular time of day. Using such a historical altitude estimate may provide an alternative altitude value that is more accurate than using altitude(s) of beacon(s) from Approach 420A, or altitude(s) associated with a region from Approach 420B.

### Use of a Trilateration-Based Estimate of the Receiver's Altitude

Under Approach 420E, a three-dimensional position (e.g., the latitude, longitude and altitude) of the receiver 120 is estimated as part of an objective function.

### Selecting an Approach

Selection of any of the above approaches may be dependent on which approaches are available to the receiver 120 or the backend 130. In some embodiments, only one approach is available, and the receiver 120 or the backend 130 must use that approach to determine the latitude and longitude of the receiver 120. In other embodiments, more than one approach is available, and the receiver 120 or the backend 130 chooses one or more of the approaches for use in determining the latitude and longitude of the receiver 120. In some cases, the estimated latitudes and longitudes from two or more approaches are combined (e.g., averaged) to determine a final estimate of the latitude and longitude. In other cases, the estimated latitudes and longitudes from two or more approaches are compared to determine if they are within an acceptable amount from each other, and therefore corroborate each other.

### Trilateration

Various techniques are used to estimate a two-dimensional or a three-dimensional position of a receiver, including trilateration, which is the process of using geometry to estimate the position of the receiver using distances traveled by different “ranging” signals that are received by the receiver from different beacons (e.g., transmitters, satellites, or other terrestrial antennas) that are at different locations (e.g., different latitudes, longitudes, and altitudes). If the transmission and reception times of a ranging signal are known, then the difference between those times multiplied by speed of light would provide an estimate of the distance traveled by that ranging signal. These distance estimates are often referred to as “range” measurements, which can include x, y and z components. Approaches for estimating the position of a receiver based on signaling from beacons are described in co-assigned U.S. Pat. No. 8,130,141, issued Mar. 6, 2012, and U.S. patent application Ser. No. 13/296,067, filed Nov. 14, 2011, which are incorporated herein in their entirety and for all purposes, except where their content conflicts with the content of this disclosure.

One of ordinary skill in the art will appreciate and understand different approaches for estimating two-dimensional or three-dimensional positions of receivers relative to beacons, including approaches that use trilateration. By way of a simplified example, a three-dimensional position of a receiver (x, y, and z) may be determined as the point where surfaces of three spheres intersect, where each sphere is sized based on a range measurement that corresponds to different beacons at different locations. Equations for the three sphere surfaces can be formulated as follows:

r₁²=x²+y²+z²,

r₂²=(x−d)²+y²+z²,

r₃²=(x−i)²+(y−j)²+z²,

where x, y and z are solved to satisfy all three equations. However, it is noted that if the receiver's altitude (z) is set as an alternative altitude value, two dimensions of a receiver's position (x and y) can be estimated more quickly than the three dimensions of the receiver's position (x, y, and z). Thus, estimates of latitude and longitude can more quickly be determined by setting the receiver's altitude to an alternative altitude value instead of also estimating the receiver's altitude. Use of such an alternative altitude value is believed to be counterintuitive, since the alternative altitude value may not be as accurate as an estimate of the receiver's altitude, but decreased time needed to estimate the two-dimensions is believed to have advantages over using a more-accurate estimate of the altitude under certain scenarios.

It is noted that an alternative altitude value may be used in connection with range measurements in order to estimate a position of a receiver. When using range measurements to satellites, for example, the alternative altitude values described herein (e.g., an altitude of a terrestrial transmitter, an altitude associated with a geographic region, or even another nearby receiver) may still be treated as the receiver's altitude to simplify the trilateration computation such that only the receiver's latitude and longitude are computed using the range measurements. It is also believed that using an alternative altitude value derived from one network of beacons (e.g., the terrestrial transmitters) with range measurements derived from another network of beacons (e.g., the satellites) is counterintuitive, but advantageous.

While discussion herein generally relates to estimating latitude and longitude based on an alternative value of altitude, it is to be understood that any two coordinates of latitude, longitude and altitude can be estimated while assuming an alternative value of the third coordinate.

### Other Aspects of Methods & Systems

Functionality and operation disclosed herein may be embodied as one or more methods implemented, in whole or in part, by machine(s)—e.g., processor(s), computers, or other suitable means known in the art—at one or more locations, which enhances the functionality of those machines, as well as computing devices that incorporate those machines. Non-transitory machine-readable media embodying program instructions adapted to be executed to implement the method(s) are also contemplated. Execution of the program instructions by one or more processors cause the processors to carry out the method(s).

It is noted that method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency.

By way of example, not by way of limitation, method(s) and processor(s) or other means may comprise: determining whether an estimate of a receiver's altitude is available; when the estimate of the receiver's altitude is available, estimating latitude and longitude coordinates of the receiver using the estimate of the receiver's altitude; and when the estimate of the receiver's altitude is not available, estimating the latitude and longitude coordinates of the receiver using an alternative altitude value that is based on one or more altitudes of one or more things other than the receiver.

In one embodiment, the estimate may be a high-accuracy estimate that is within a desired number of meters (e.g., within three meters) of the actual altitude. In one implementation, a processor that estimates a receiver's altitudes must determine high-accuracy estimates for those altitudes over a certain percentage of all estimates (e.g., where greater than or equal to 90% of all estimates are high-accuracy measurements such that a processor that determines ten estimates will determine nine high-accuracy estimates within the desired number of meters of the actual altitude).

Of course, there are different ways to determine a high-accuracy estimate. In one embodiment, a receiver knows what floor it is on based on receiving signals of opportunity (e.g., local area network signals that are confined to a floor, RF tags, and other options), and that knowledge is used to get a high-accuracy estimate of the receiver's altitude, which can be used to estimate latitude and longitude. In another embodiment, the high-accuracy estimate of the receiver's altitude is based on a measurement of pressure at the receiver and one or more measurements of pressure at one or more terrestrial transmitters from which the receiver receives one or more signals (e.g., ranging signals).

In one embodiment, the alternative altitude value is based on an altitude of at least one transmitter from a group of terrestrial transmitters from which the receiver receives at least one signals (e.g., ranging signals).

Method(s) and processor(s) or other means may further or alternatively comprise: determining altitudes of each transmitter from the group of terrestrial transmitters, wherein the alternative altitude value is the lowest, highest, average, median, or most common altitude from the altitudes of each transmitter.

Method(s) and processor(s) or other means may further or alternatively comprise: determining altitudes of each transmitter from the group of terrestrial transmitters, wherein the alternative altitude value is an altitude of a transmitter, from the group of terrestrial transmitters, that is closest to the receiver.

In one embodiment, the alternative altitude value is based on an altitude of a thing (e.g., a natural surface or a manmade surface) other than the receiver in a geographical region within which the receiver is known to reside.

In one embodiment, the altitude of the geographical region is based on a mathematical combination of two or more altitudes in the geographic region.

In one embodiment, the alternative altitude value is based on one or more historical estimates of the receiver's altitude.

In one embodiment, the one or more historical altitudes correspond to altitudes of the receiver during one or more days other than the current day.

In one embodiment, the one or more historical altitudes correspond to altitudes of the receiver at one or more times of day that are within a predetermined amount of time from a time of day corresponding to when the receiver was located at the estimated latitude and longitude coordinates.

Method(s) and processor(s) or other means may further or alternatively comprise: estimating the latitude coordinate and the longitude coordinate of the receiver using two or more of an altitude of a terrestrial transmitter, an altitude of a surface in a geographical region within which the receiver resides, or a historical altitude of the receiver.

Method(s) and processor(s) or other means may further or alternatively comprise: comparing the two or more altitudes; selecting, based on the comparison, a first altitude from the two or more altitudes; and using the first altitude, but none of the remaining altitudes from the two or more altitudes, to estimate the latitude coordinate and the longitude coordinate of the receiver.

Method(s) and processor(s) or other means may further or alternatively comprise: determining the alternative altitude value based on a mathematical combination of the two or more altitudes.

By way of example, not by way of limitation, one or more apparatuses may comprise hardware modules that perform the methods or particular steps of the methods disclosed herein. In one embodiment, one or more apparatuses include: a determination module configured to determine whether a high-accuracy estimate of a receiver's altitude is available; and an estimation module configured to estimate latitude and longitude coordinates of the receiver using the high-accuracy estimate of the receiver's altitude when the high-accuracy estimate of the receiver's altitude is available, and estimate the latitude and longitude coordinates of the receiver using an alternative altitude value that is based on one or more altitudes of one or more things other than the receiver when the high-accuracy estimate of the receiver's altitude is not available. The determination module includes one or more inputs to receive information used to perform the determination, and one or more outputs to send information specifying the determination. The estimation module includes one or more inputs to receive information used to estimate the latitude and longitude, and one or more outputs to send information specifying the estimated latitude and longitude.

### Examples of Other Features in Some Embodiments

A “receiver” may be in the form of a computing device (e.g., a mobile phone, a tablet, a PDA, a laptop, a digital camera, a tracking tag). A receiver may also take the form of any component of the computer, including a processor.

Processing by the receiver can also occur at a server.

The illustrative methods described herein may be implemented, performed, or otherwise controlled by suitable hardware known or later-developed by one of skill in the art, or by firmware or software executed by processor(s), or any combination of hardware, software and firmware. Software may be downloadable and non-downloadable at a particular system. Such software, once loaded on a machine, changes the operation of that machine.

Systems on which methods described herein are performed may include one or more means that implement those methods. For example, such means may include processor(s) or other hardware that, when executing instructions (e.g., embodied in software or firmware), perform any method step disclosed herein. A processor may include, or be included within, a computer or computing device, a controller, an integrated circuit, a “chip”, a system on a chip, a server, other programmable logic devices, other circuitry, or any combination thereof.

“Memory” may be accessible by a machine (e.g., a processor), such that the machine can read/write information from/to the memory. Memory may be integral with or separate from the machine. Memory may include a non-transitory machine-readable medium having machine-readable program code (e.g., instructions) embodied therein that is adapted to be executed to implement any or all of the methods and method steps disclosed herein. Memory may include any available storage media, including removable, non-removable, volatile, and non-volatile media—e.g., integrated circuit media, magnetic storage media, optical storage media, or any other computer data storage media. As used herein, machine-readable media includes all forms of machine-readable media except to the extent that such media is deemed to be non-statutory (e.g., transitory propagating signals).

All of the information disclosed herein may be represented by data, and that data may be transmitted over any communication pathway using any protocol, stored on data source(s), and processed by a processor. Transmission of data may be carried out using a variety of wires, cables, radio signals and infrared light beams, and an even greater variety of connectors, plugs and protocols even if not shown or explicitly described. Systems may exchange information with each other using any communication technology. Data, instructions, commands, information, signals, bits, symbols, and chips and the like may be represented by voltages, currents, electromagnetic waves, magnetic fields or particles, or optical fields or particles.

Features in system figures that are illustrated as rectangles may refer to hardware, firmware or software. It is noted that lines linking two such features may be illustrative of data transfer between those features. Such transfer may occur directly between those features or through intermediate features. Where no line connects two features, transfer of data between those features is contemplated unless otherwise stated.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

It is noted that the term “GPS” may refer to any Global Navigation Satellite Systems (GNSS), such as GLONASS, Galileo, and Compass/Beidou, and vice versa.

1. A method for estimating latitude and longitude coordinates of a receiver, the method comprising:
determining whether a high-accuracy estimate of a receiver's altitude is available;
when the high-accuracy estimate of the receiver's altitude is available, estimating latitude and longitude coordinates of the receiver using the high-accuracy estimate of the receiver's altitude; and
when the high-accuracy estimate of the receiver's altitude is not available, estimating the latitude and longitude coordinates of the receiver using an alternative altitude value that is based on one or more altitudes of one or more things other than the receiver.

2. The method of claim 1, wherein the high-accuracy estimate of the receiver's altitude is based on a measurement of pressure at the receiver and one or more measurements of pressure at one or more terrestrial transmitters from which the receiver receives one or more signals.

3. The method of claim 1, wherein the alternative altitude value is based on an altitude of at least one transmitter from a group of terrestrial transmitters from which the receiver receives at least one ranging signal.

4. The method of claim 3, wherein the method comprises:
determining altitudes of each transmitter from the group of terrestrial transmitters,
wherein the alternative altitude value is the lowest altitude from the altitudes of each transmitter.

5. The method of claim 3, wherein the method comprises:
determining altitudes of each transmitter from the group of terrestrial transmitters,
wherein the alternative altitude value is an altitude of a transmitter, from the group of terrestrial transmitters, that is closer to the receiver than all other transmitters from the group.

6. The method of claim 1, wherein the alternative altitude value is an altitude of a thing other than the receiver in a geographical region within which the receiver resides.

7. The method of claim 6, wherein the altitude of the geographical region is based on a mathematical combination of two or more altitudes associated with the geographic region.

8. The method of claim 1, wherein the alternative altitude value is based on one or more historical altitudes of the receiver.

9. The method of claim 8, wherein the one or more historical altitudes correspond to altitudes of the receiver during one or more previous days.

10. The method of claim 9, wherein the one or more historical altitudes correspond to altitudes of the receiver at one or more times of day that are within a predetermined amount of time from a time of day corresponding to when the receiver is being located at the estimated latitude and longitude coordinates.

11. The method of claim 1, wherein the method comprises:
estimating the latitude coordinate and the longitude coordinate of the receiver using two or more of: an altitude of a terrestrial transmitter, an altitude of a surface in a geographical region within which the receiver resides, or a historical altitude of the receiver.

12. The method of claim 11, wherein the method comprises:
comparing the two or more altitudes;
selecting, based on the comparison, a first altitude from the two or more altitudes; and
using the first altitude, but none of the remaining altitudes from the two or more altitudes, to estimate the latitude coordinate and the longitude coordinate of the receiver.

13. The method of claim 11, wherein the method comprises:
determining the alternative altitude value based on a mathematical combination of the two or more altitudes.

14. A non-transitory machine-readable medium embodying program instructions adapted to be executed to implement a method for estimating latitude and longitude coordinates of a receiver, the method comprising:
determining whether a high-accuracy estimate of a receiver's altitude is available;
when the high-accuracy estimate of the receiver's altitude is available, estimating latitude and longitude coordinates of the receiver using the high-accuracy estimate of the receiver's altitude; and
when the high-accuracy estimate of the receiver's altitude is not available, estimating the latitude and longitude coordinates of the receiver using an alternative altitude value that is based on one or more altitudes of one or more things other than the receiver.

15. The non-transitory machine-readable medium of claim 14, wherein the high-accuracy estimate of the receiver's altitude is based on a measurement of pressure at the receiver and one or more measurements of pressure at one or more terrestrial transmitters from which the receiver receives one or more signals.

16. The non-transitory machine-readable medium of claim 14, wherein the alternative altitude value is an altitude of a thing other than the receiver in a geographical region within which the receiver resides.

17. The non-transitory machine-readable medium of claim 14, wherein the alternative altitude value is an altitude of a transmitter, from a group of transmitters transmitting signals received by the receiver, that is closer to the receiver than all other transmitters from the group.

18. The non-transitory machine-readable medium of claim 14, wherein the alternative altitude value is based on one or more historical altitudes of the receiver.

19. The non-transitory machine-readable medium of claim 14, wherein the method comprises:
estimating the latitude coordinate and the longitude coordinate of the receiver using two or more of an altitude of a terrestrial transmitter, an altitude of a surface in a geographical region within which the receiver resides, or a historical altitude of the receiver.

20. A system for estimating latitude and longitude coordinates of a receiver, the system comprising one or more modules that:
determine whether a high-accuracy estimate of the receiver's altitude is available;
when the high-accuracy estimate of the receiver's altitude is available, estimate latitude and longitude coordinates of the receiver using the high-accuracy estimate of the receiver's altitude; and
when the high-accuracy estimate of the receiver's altitude is not available, estimate the latitude and longitude coordinates of the receiver using an alternative altitude value that is based on one or more altitudes of one or more things other than the receiver.
